(19) United States
(12) Patent Application Publication
(10) Pub. No.: US 2011/0316832 A1
(43) Pub. Date: Dec. 29, 2011

(54) PIXEL DRIVE SCHEME HAVING IMPROVED RELEASE CHARACTERISTICS

(75) Inventor: Mark Todorovich, San Diego, CA (US)

(73) Assignee: QUALCOMM MEMS Technologies, Inc., San Diego, CA (US)

(21) Appl. No.: 12/823,070

(22) Filed: Jun. 24, 2010

(51) Int. Cl. G06F 3/038

(52) U.S. Cl. 345/210

(57) ABSTRACT

Electromechanical devices such as MEMS can be controlled by “drive schemes” comprising electrical signals applied to the display to cause selective actuation or release of the electromechanical devices. In some drive schemes, all pixels on a line are released during a phase when a release voltage is applied along the common line. In some invention embodiments, the release phase sets the common line voltage to the maximum segment drive voltage for a portion of the release phase and the minimum segment drive voltage for the remainder of the release phase. This ensures that all electromechanical devices have a resulting voltage of zero during a portion of the release phase sufficient to release the devices without regard to the segment line voltages. This scheme eliminates slow and no release problems and also eliminates the need for additional voltage transitions on the segment lines.

### BACKGROUND

1. Field of the Invention

This invention is related to methods and devices for driving electromechanical devices such as interferometric modulators.

2. Description of the Related Art

Microelectromechanical systems (MEMS) include micromechanical elements, actuators, and electronics. Micromechanical elements may be created using deposition, etching, and or other micromachining processes that etch away parts of substrates and/or deposited material layers or that add layers to form electrical and electromechanical devices. One type of MEMS device is called an interferometric modulator. As used herein, the term interferometric modulator or interferometric light modulator refers to a device that selectively absorbs and/or reflects light using the principles of optical interference. In certain embodiments, an interferometric modulator may comprise a pair of conductive plates, one or both of which may be transparent and/or reflective in whole or part and capable of relative motion upon application of an appropriate electrical signal. In a particular embodiment, one plate may comprise a stationary layer deposited on a substrate and the other plate may comprise a metallic membrane separated from the stationary layer by an air gap. As described herein in more detail, the position of one plate in relation to another can change the optical interference of light incident on the interferometric modulator. Such devices have a wide range of applications, and it would be beneficial in the art to utilize and/or modify the characteristics of these types of devices so that their features can be exploited in improving existing products and creating new products that have not yet been developed.

### SUMMARY

Briefly and in general terms, the present invention provides methods and apparatuses for implementing electromechanical device drive schemes wherein a multi-phase release waveform ensures that all electromechanical devices achieve a target release voltage during a portion of the release phase sufficient to release the devices without regard to the segment line voltages. Further, embodiments of the methods and apparatuses described herein eliminate slow release of a pixel and failure of a pixel to release during the release phase while also eliminating the need for additional voltage transitions on the segment lines.

One embodiment is a method of releasing an electromechanical device including applying a first release voltage on a common line for a first release time period; applying a second release voltage on a common line for a second release time period, wherein the second release voltage is different than the first release voltage; and wherein a resulting voltage across the electromechanical device is closer to a target release voltage during one of the first or second release time periods than the other.

Another embodiment is a method of driving an electromechanical device, the electromechanical device including a first electrode in electrical communication with a segment line spaced apart from a second electrode in electrical communication with a common line, the method including applying a segment voltage on the segment line, wherein the segment voltage varies between a maximum segment voltage and a minimum segment voltage, and wherein a difference between the maximum segment voltage and the minimum segment voltage is less than a width of a hysteresis window of the electromechanical device; applying a release waveform on the common line, wherein the release waveform is maintained at a first release voltage substantially equal to the maximum segment voltage for a first release time period and then maintained at a second release voltage substantially equal to the minimum segment voltage for a second release time period; applying an addressing voltage on the common line, wherein the addressing voltage is configured to cause the electromechanical device to actuate based upon the state of the segment voltage; and applying a hold voltage on the common line, wherein the hold voltage is configured to maintain the electromechanical device in its current state, regardless of the state of the segment voltage.

Yet another embodiment is a display device including an array of electromechanical display elements, wherein each display element is in electrical communication with a common line and a segment line; and driver circuitry configured to perform a method of driving the electromechanical display elements, wherein the method includes applying a segment voltage on the segment line, wherein the segment voltage varies between a maximum segment voltage and a minimum segment voltage, and wherein a difference between the maximum segment voltage and the minimum segment voltage is less than a width of a hysteresis window of the electromechanical device; applying a release waveform on the common line, wherein the release waveform is maintained at a first release voltage substantially equal to the maximum segment voltage for a first release time period and then maintained at a second release voltage substantially equal to the minimum segment voltage for a second release time period; applying an addressing voltage on the common line, wherein the addressing voltage is configured to cause the electromechanical device to actuate based upon the state of the segment voltage; and applying a hold voltage on the common line, wherein the hold voltage is configured to maintain the electromechanical device in its current state, regardless of the state of the segment voltage.

Another embodiment is a display system including one or more electromechanical devices, wherein each electromechanical device is in electrical communication with a segment line spaced apart from a second electrode in electrical communication with a common line; a driver circuit configured to apply a first release voltage on a common line for a first release time period; a driver circuit configured to apply a second release voltage on a common line for a second release time period, wherein the second release voltage is different than the first release voltage; and wherein a resulting voltage across the electromechanical device is closer to a target release voltage during one of the first or second release time periods than the other.

A further embodiment is a display system including one or more electromechanical devices, wherein each electromechanical device is in electrical communication with a segment line spaced apart from a second electrode in electrical communication with a common line; means for applying a first release voltage on a common line for a first release time period; means for applying a second release voltage on a common line for a second release time period, wherein the second release voltage is different than the first release voltage; and wherein a resulting voltage across the electromechanical device is closer to a target release voltage during one of the first or second release time periods than the other.

Another embodiment is a display device including an array of electromechanical display elements, wherein each display element is in electrical communication with a common line and a segment line; means for applying a segment voltage on the segment line, wherein the segment voltage varies between a maximum segment voltage and a minimum segment voltage, and wherein a difference between the maximum segment voltage and the minimum segment voltage is less than a width of a hysteresis window of the electromechanical device; means for applying a release waveform on the common line, wherein the release waveform is maintained at a first release voltage substantially equal to the maximum segment voltage for a first release time period and then maintained at a second release voltage substantially equal to the minimum segment voltage for a second release time period; means for applying an addressing voltage on the common line, wherein the addressing voltage is configured to cause the electromechanical device to actuate based upon the state of the segment voltage; and means for applying a hold voltage on the common line, wherein the hold voltage is configured to maintain the electromechanical device in its current state, regardless of the state of the segment voltage.

### BRIEF DESCRIPTION OF THE DRAWINGS

FIG. 1 is an isometric view depicting a portion of one embodiment of an interferometric modulator display in which a movable reflective layer of a first interferometric modulator is in a relaxed position and a movable reflective layer of a second interferometric modulator is in an actuated position.

FIG. 2 is a system block diagram illustrating one embodiment of an electronic device incorporating a 3×3 interferometric modulator display.

FIG. 3 is a diagram of movable mirror position versus applied voltage for one exemplary embodiment of an interferometric modulator of FIG. 1.

FIG. 4 is an illustration of a set of row and column voltages that may be used to drive an interferometric modulator display.

FIGS. 5A and 5B illustrate one exemplary timing diagram for common line and segment line signals that may be used to write a frame of display data to the 3×3 interferometric modulator display of FIG. 2.

FIG. 6 is an illustration of a set of common and segment voltages that may be used to drive an interferometric modulator display.

FIGS. 7A and 7B illustrate one exemplary timing diagram 7B for common and segment line signals that may be used to write a frame of display data to the 3×3 interferometric modulator display of 7A.

FIG. 8 illustrates one exemplary timing diagram for common and segment line signals for a drive scheme.

FIG. 9 is a diagram of movable mirror position versus applied voltage for one exemplary embodiment of an interferometric modulator showing the effect of non-ideal release voltages.

FIG. 10 shows another exemplary hysteresis curve for an exemplary electromechanical device such as an IMOD pixel

FIG. 11 illustrates one exemplary timing diagram for common line and segment line signals for an improved drive scheme that improves release characteristics of electromechanical devices.

### DETAILED DESCRIPTION OF PREFERRED EMBODIMENTS

The following detailed description is directed to certain specific embodiments. However, the teachings herein can be applied in a multitude of different ways. In this description, reference is made to the drawings wherein like parts are designated with like numerals throughout. The embodiments may be implemented in any device that is configured to display an image, whether in motion (e.g., video) or stationary (e.g., still image), and whether textual or pictorial. More particularly, it is contemplated that the embodiments may be implemented in or associated with a variety of electronic devices such as, but not limited to, mobile telephones, wireless devices, personal data assistants (PDAs), hand-held or portable computers, GPS receivers/navigators, cameras, MP3 players, camcorders, game consoles, wrist watches, clocks, calculators, television monitors, flat panel displays, computer monitors, auto displays (e.g., odometer display, etc.), cockpit controls and/or displays, display of camera views (e.g., display of a rear view camera in a vehicle), electronic photographs, electronic billboards or signs, projectors, architectural structures, packaging, and aesthetic structures (e.g., display of images on a piece of jewelry). MEMS devices of similar structure to those described herein can also be used in non-display applications such as in electronic switching devices.

Electromechanical devices such as MEMS can be controlled by “drive schemes” comprising electrical signals applied to the display to cause selective actuation or release of the electromechanical devices. In some drive schemes, all pixels on a line are released during a phase when a release voltage is applied along the common line. In some invention embodiments, the release phase sets the common line voltage to the maximum segment drive voltage for a portion of the release phase and the minimum segment drive voltage for the remainder of the release phase. This ensures that all electromechanical devices have a resulting voltage of zero during a portion of the release phase sufficient to release the devices without regard to the segment line voltages. This scheme eliminates slow and no release problems and also eliminates the need for additional voltage transitions on the segment lines.

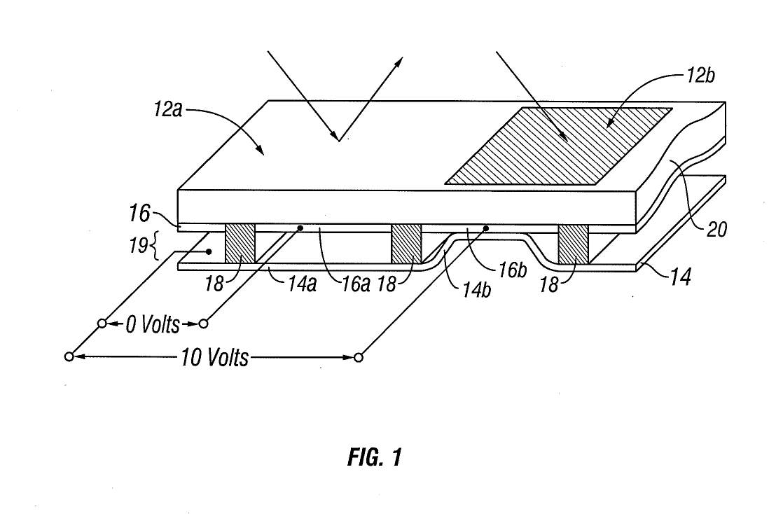

One interferometric modulator display embodiment comprising an interferometric MEMS display element is illustrated in FIG. 1. In these devices, the pixels are in either a bright or dark state. In the bright (“relaxed” or “open” or “released”) state, the display element reflects a large portion of incident visible light to a user. When in the dark (“actuated” or “closed”) state, the display element reflects little incident visible light to the user. Depending on the embodiment, the light reflectance properties of the “on” and “off” states may be reversed. Additionally, MEMS pixels can be configured to reflect predominantly at selected colors, allowing for a color display in addition to black and white.

FIG. 1 is an isometric view depicting two adjacent pixels in a series of pixels of a visual display, wherein each pixel comprises a MEMS interferometric modulator. In some embodiments, an interferometric modulator display comprises a row/column array of these interferometric modulators. Each interferometric modulator includes a pair of reflective layers positioned at a variable and controllable distance from each other to form a resonant optical gap with at least one variable dimension. In one embodiment, one of the reflective layers may be moved between two positions. In the first position, referred to herein as the relaxed position, the movable reflective layer is positioned at a relatively large distance from a fixed partially reflective layer. In the second position, referred to herein as the actuated position, the movable reflective layer is positioned more closely adjacent to the partially reflective layer. Incident light that reflects from the two layers interferes constructively or destructively depending on the position of the movable reflective layer, producing either an overall reflective or non-reflective state for each pixel.

The depicted portion of the pixel array in FIG. 1 includes two adjacent interferometric modulators 12a and 12b. In the interferometric modulator 12a on the left, a movable reflective layer 14a is illustrated in a relaxed position at a predetermined distance from an optical stack 16a, which includes a partially reflective layer. In the interferometric modulator 12b on the right, the movable reflective layer 14b is illustrated in an actuated position adjacent to the optical stack 16b.

The optical stacks 16a and 16b (collectively referred to as optical stack 16), as referenced herein, typically comprise several fused layers, which can include an electrode layer, such as indium tin oxide (ITO), a partially reflective layer, such as chromium, and a transparent dielectric. The optical stack 16 is thus electrically conductive, partially transparent and partially reflective, and may be fabricated, for example, by depositing one or more of the above layers onto a transparent substrate 20. The partially reflective layer can be formed from a variety of materials that are partially reflective such as various metals, semiconductors, and dielectrics. The partially reflective layer can be formed of one or more layers of materials, and each of the layers can be formed of a single material or a combination of materials.

In some embodiments, the layers of the optical stack 16 are patterned into parallel strips, and may form row electrodes in a display device as described further below. The movable reflective layers 14a, 14b may be formed as a series of parallel strips of a deposited metal layer or layers (orthogonal to the row electrodes of 16a, 16b) to form columns deposited on top of posts 18 and an intervening sacrificial material deposited between the posts 18. When the sacrificial material is etched away, the movable reflective layers 14a, 14b are separated from the optical stacks 16a, 16b by a defined gap 19. A highly conductive and reflective material such as aluminum may be used for the reflective layers 14, and these strips may form column electrodes in a display device. Note that FIG. 1 may not be to scale. In some embodiments, the spacing between posts 18 may be on the order of 10-100 um, while the gap 19 may be on the order of <1000 Angstroms.

With no applied voltage, the gap 19 remains between the movable reflective layer 14a and optical stack 16a, with the movable reflective layer 14a in a mechanically relaxed state, as illustrated by the pixel 12a in FIG. 1. However, when a potential (voltage) difference is applied to a selected row and column, the capacitor formed at the intersection of the row and column electrodes at the corresponding pixel becomes charged, and electrostatic forces pull the electrodes together. If the voltage is high enough, the movable reflective layer 14 is deformed and is forced against the optical stack 16. A dielectric layer (not illustrated in this figure) within the optical stack 16 may prevent shorting and control the separation distance between layers 14 and 16, as illustrated by actuated pixel 12b on the right in FIG. 1. The behavior is the same regardless of the polarity of the applied potential difference.

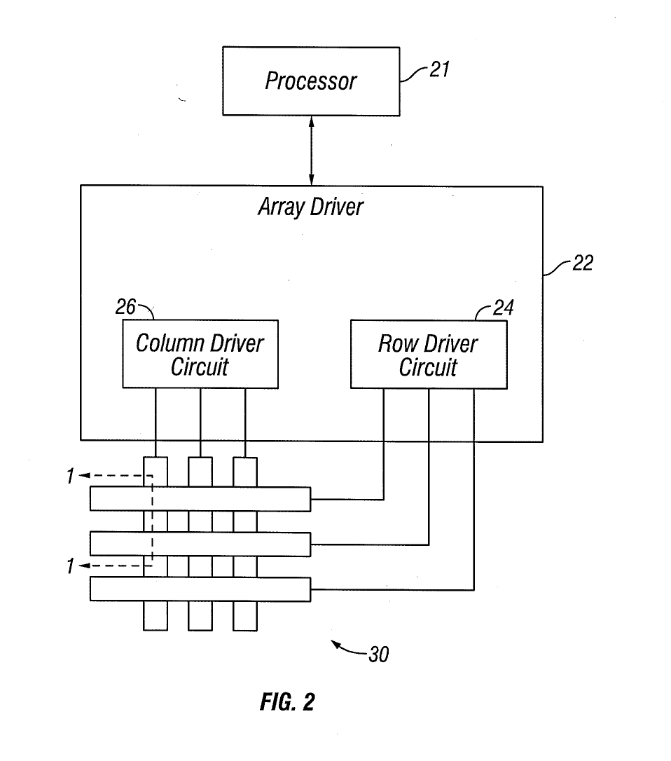

FIGS. 2 through 5 illustrate one exemplary process and system for using an array of interferometric modulators in a display application.

FIG. 2 is a system block diagram illustrating one embodiment of an electronic device that may incorporate interferometric modulators. The electronic device includes a processor 21 which may be any general purpose single- or multi-chip microprocessor such as an ARM®, Pentium®, 8051, MIPS®, Power PC®, or ALPHA®, or any special purpose microprocessor such as a digital signal processor, microcontroller, or a programmable gate array. As is conventional in the art, the processor 21 may be configured to execute one or more software modules. In addition to executing an operating system, the processor may be configured to execute one or more software applications, including a web browser, a telephone application, an email program, or any other software application.

In one embodiment, the processor 21 is also configured to communicate with an array driver 22. In one embodiment, the array driver 22 includes a row driver circuit 24 and a column driver circuit 26 that provide signals to a display array or panel 30. The cross section of the array illustrated in FIG. 1 is shown by the lines 1-1 in FIG. 2. Note that although FIG. 2 illustrates a 3×3 array of interferometric modulators for the sake of clarity, the display array 30 may contain a very large number of interferometric modulators, and may have a different number of interferometric modulators in rows than in columns (e.g., 300 pixels per row by 190 pixels per column).

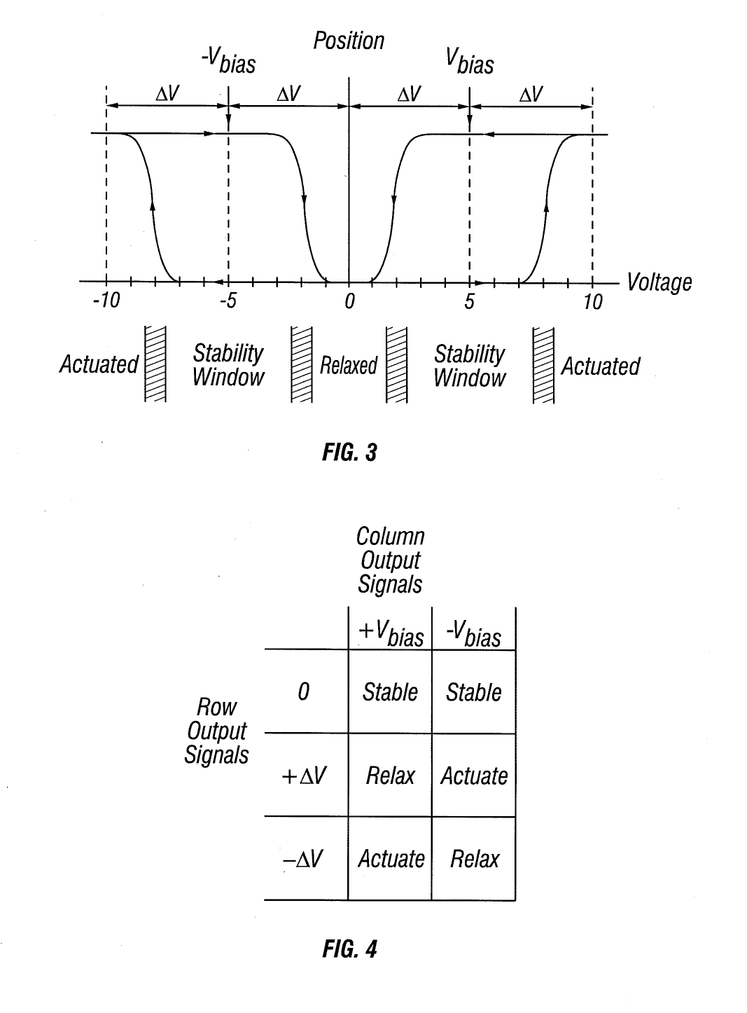

FIG. 3 is a diagram of movable mirror position versus applied voltage for one exemplary embodiment of an interferometric modulator of FIG. 1. For MEMS interferometric modulators, the row/column actuation protocol may take advantage of a hysteresis property of these devices as illustrated in FIG. 3. An interferometric modulator may require, for example, a 10 volt potential difference to cause a movable layer to deform from the relaxed state to the actuated state. However, when the voltage is reduced from that value, the movable layer maintains its state as the voltage drops back below 10 volts. In the exemplary embodiment of FIG. 3, the movable layer does not relax completely until the voltage drops below 2 volts. There is thus a range of voltage, about 3 to 7 V in the example illustrated in FIG. 3, where there exists a window of applied voltage within which the device is stable in either the relaxed or actuated state. This is referred to herein as the “hysteresis window” or “stability window.” For a display array having the hysteresis characteristics of FIG. 3, the row/column actuation protocol can be designed such that during row strobing, pixels in the strobed row that are to be actuated are exposed to a voltage difference of about 10 volts, and pixels that are to be relaxed are exposed to a voltage difference of close to zero volts. After the strobe, the pixels are exposed to a steady state or bias voltage difference of about 5 volts such that they remain in whatever state the row strobe put them in. After being written, each pixel sees a potential difference within the “stability window” of 3-7 volts in this example. This feature makes the pixel design illustrated in FIG. 1 stable under the same applied voltage conditions in either an actuated or relaxed pre-existing state. Since each pixel of the interferometric modulator, whether in the actuated or relaxed state, is essentially a capacitor formed by the fixed and moving reflective layers, this stable state can be held at a voltage within the hysteresis window with almost no power dissipation. Essentially no current flows into the pixel if the applied potential is fixed. Although the hysteresis curves of FIG. 3 are symmetric about zero volts, trapped charge due to manufacturing processes and use of the device can cause right and left shifts in the hysteresis windows such that the release and actuation voltages for one hysteresis window are closer to zero than the other. The amount of shift is often referred to as the “offset” of the hysteresis curve.

As described further below, in typical applications, a frame of an image may be created by sending a set of data signals (each having a certain voltage level) across the set of column electrodes in accordance with the desired set of actuated pixels in the first row. A row pulse is then applied to a first row electrode, actuating the pixels corresponding to the set of data signals. The set of data signals is then changed to correspond to the desired set of actuated pixels in a second row. A pulse is then applied to the second row electrode, actuating the appropriate pixels in the second row in accordance with the data signals. The first row of pixels are unaffected by the second row pulse, and remain in the state they were set to during the first row pulse. This may be repeated for the entire series of rows in a sequential fashion to produce the frame. Generally, the frames are refreshed and/or updated with new image data by continually repeating this process at some desired number of frames per second. A wide variety of protocols for driving row and column electrodes of pixel arrays to produce image frames may be used.

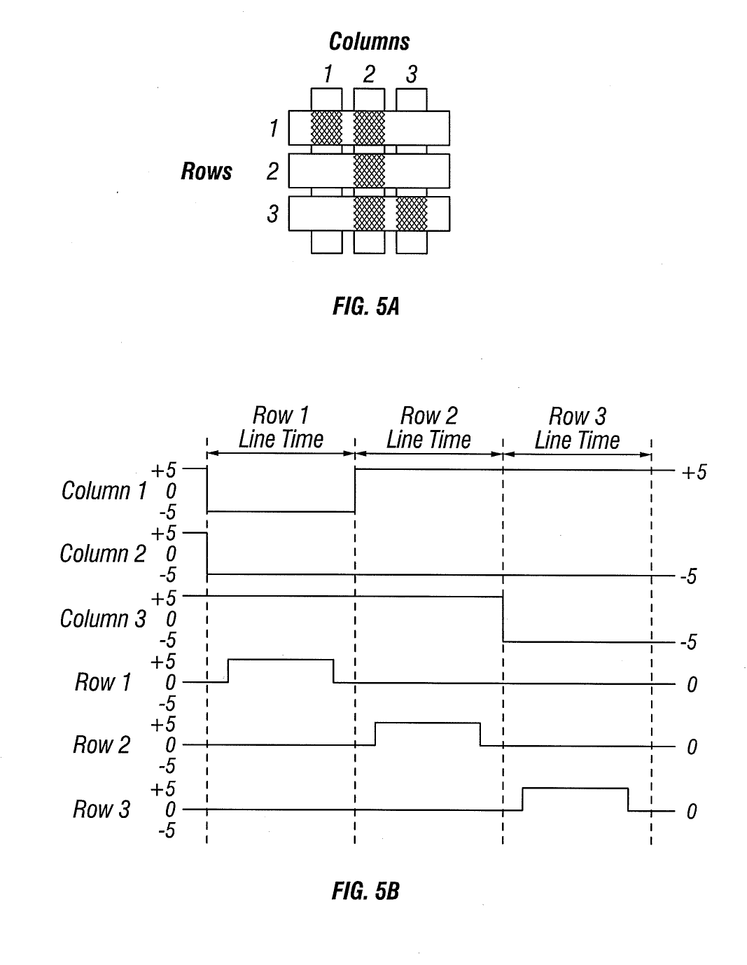

FIGS. 4 and 5 illustrate one possible actuation protocol for creating a display frame on the 3×3 array of FIG. 2. FIG. 4 illustrates a possible set of column and row voltage levels that may be used for pixels exhibiting the hysteresis curves of FIG. 3. In the FIG. 4 embodiment, actuating a pixel involves setting the appropriate column to −V_{bias}, and the appropriate row to +ΔV, which may correspond to −5 volts and +5 volts respectively Relaxing the pixel is accomplished by setting the appropriate column to +V_{bias}, and the appropriate row to the same +ΔV, producing a zero volt potential difference across the pixel. In those rows where the row voltage is held at zero volts, the pixels are stable in whatever state they were originally in, regardless of whether the column is at +V_{bias}, or −V_{bias}. As is also illustrated in FIG. 4, voltages of opposite polarity than those described above can be used, e.g., actuating a pixel can involve setting the appropriate column to +V_{bias}, and the appropriate row to −ΔV. In this embodiment, releasing the pixel is accomplished by setting the appropriate column to −V_{bias}, and the appropriate row to the same −ΔV, producing a zero volt potential difference across the pixel.

FIG. 5B is a timing diagram showing a series of row and column signals applied to the 3×3 array of FIG. 2 which will result in the display arrangement illustrated in FIG. 5A, where actuated pixels are non-reflective. Prior to writing the frame illustrated in FIG. 5A, the pixels can be in any state, and in this example, all the rows are initially at 0 volts, and all the columns are at +5 volts. With these applied voltages, all pixels are stable in their existing actuated or relaxed states.

In the FIG. 5A frame, pixels (1,1), (1,2), (2,2), (3,2) and (3,3) are actuated. To accomplish this, during a “line time” for row 1, columns 1 and 2 are set to −5 volts, and column 3 is set to +5 volts. This does not change the state of any pixels, because all the pixels remain in the 3-7 volt stability window. Row 1 is then strobed with a pulse that goes from 0, up to 5 volts, and back to zero. This actuates the (1,1) and (1,2) pixels and relaxes the (1,3) pixel. No other pixels in the array are affected. To set row 2 as desired, column 2 is set to −5 volts, and columns 1 and 3 are set to +5 volts. The same strobe applied to row 2 will then actuate pixel (2,2) and relax pixels (2,1) and (2,3). Again, no other pixels of the array are affected. Row 3 is similarly set by setting columns 2 and 3 to −5 volts, and column 1 to +5 volts. The row 3 strobe sets the row 3 pixels as shown in FIG. 5A. After writing the frame, the row potentials are zero, and the column potentials can remain at either +5 or −5 volts, and the display is then stable in the arrangement of FIG. 5A. The same procedure can be employed for arrays of dozens or hundreds of rows and columns. The timing, sequence, and levels of voltages used to perform row and column actuation can be varied widely within the general principles outlined above, and the above example is exemplary only, and any actuation voltage method can be used with the systems and methods described herein.

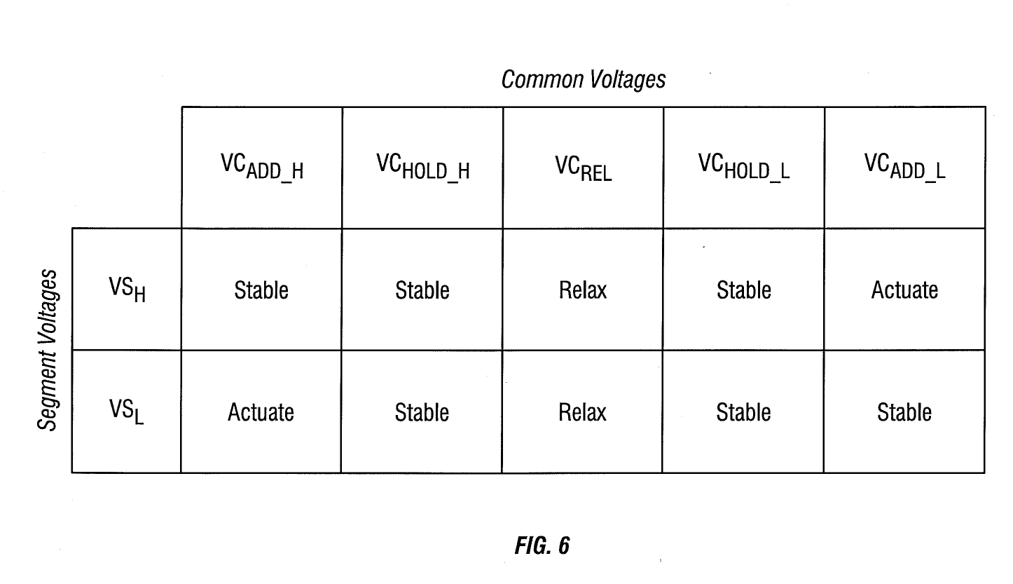

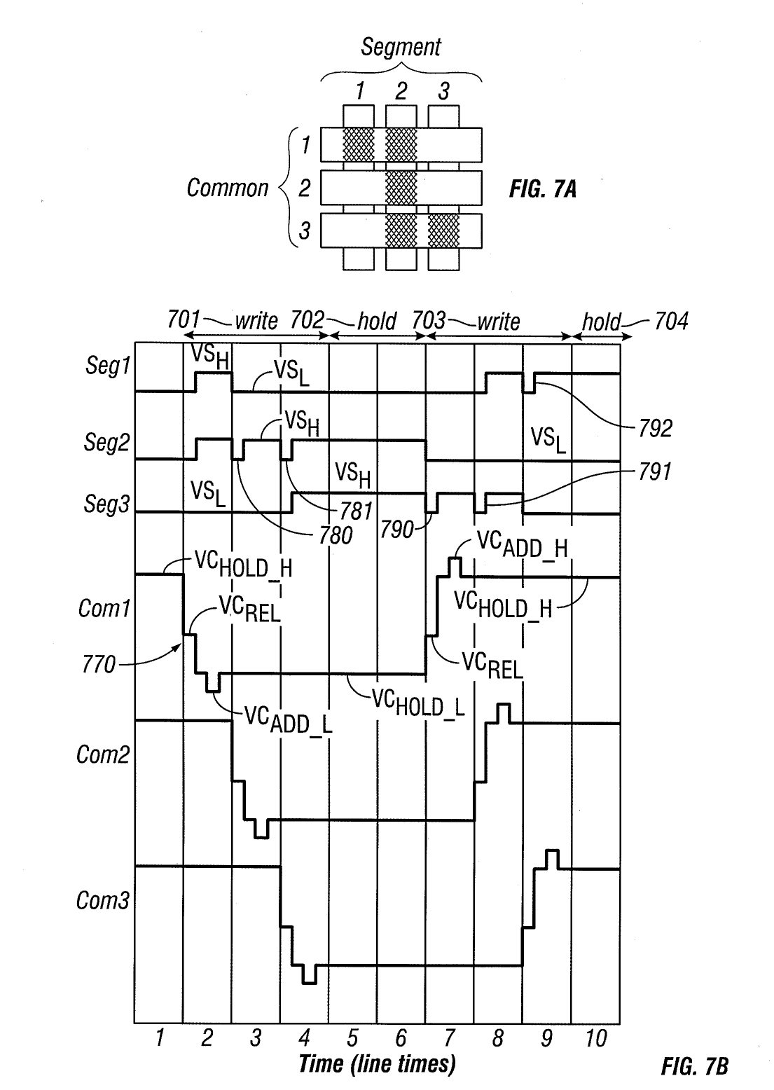

FIGS. 6 through 7B illustrate an alternate actuation protocol for driving an array of electromechanical devices such as an array of interferometric modulators. FIG. 6 illustrates a possible set of segment and common line voltage levels that may be used for modulators exhibiting the hysteresis properties illustrated in FIG. 3. In the embodiment of FIG. 6 five possible voltages may be applied along a common line (which may be either a row or column line, in various embodiments) in order to address specific common lines, and at least two possible voltages may be applied along segment lines.

FIG. 6 further describes the interaction of the common and segment line voltages. When a release voltage VC_{REL} is applied along a common line, all interferometric modulator elements along the common line will be placed in a relaxed state, alternatively referred to as a released or unactuated state, regardless of which voltage is applied along the segment lines. The release voltage VC_{REL} and the high and low segment voltages VS_{H} and VS_{L}, respectively, are selected accordingly. In particular, when the release voltage VC_{REL} is applied along a common line, the resulting voltage across the modulator (alternatively referred to as a pixel voltage) is within the relaxation window (see FIG. 3, also referred to as a release window) both when the high segment voltage VS_{H} and the low segment voltage VS_{L} are applied along the corresponding segment line. The difference between the high and low segment voltage, also referred to as the segment voltage swing, is less than the width of the relaxation window.

When a hold voltage is applied on a common line, such as a high hold voltage VC_{HOLD}_{_{—}}_{H} or a low hold voltage VC_{HOLD}_{_{—}}_{L}, the state of the interferometric modulator will remain constant. A relaxed modulator will remain in a relaxed position, and an actuated modulator will remain in an actuated position. The hold voltages are selected such that the pixel voltage will remain within a stability window of the interferometric modulator both when the high segment voltage VS_{H} and the low segment voltage VS_{L} are applied along the corresponding segment line. The segment voltage swing is thus less than the width of either the positive or the negative stability window.

When an addressing voltage is applied on a common line, such as high addressing voltage VC_{ADD}_{_{—}}_{H} or low addressing voltage VC_{ADD}_{_{—}}_{L}, data can be selectively written to the modulators along that line by application of segment voltages along the respective segment lines. The addressing voltages are selected such that when an addressing voltage is applied along a common line, the pixel voltage will be within a stability window when one of the segment voltages is applied along the segment line, but beyond the stability window when the other is applied, causing actuation of the pixel. The particular segment voltage which causes actuation will vary depending upon which addressing voltage is used. When the high addressing voltage VC_{ADD}_{_{—}}_{H} is applied along the common line, application of the high segment voltage VS_{H} will cause a modulator to remain in its current position, while application of the low segment voltage VS_{L} causes actuation of the modulator. Actuation is achieved in this example because the absolute voltage across the pixel is the difference between VC_{ADD}_{_{—}}_{H} and VS_{L}, which is sufficient to actuate the pixel. The effect of the segment voltages will be the opposite when a low addressing voltage VC_{ADD}_{_{—}}_{L} is applied, with high segment voltage VS_{H} causing actuation of the modulator, and low segment voltage VS_{L} having no effect on the state of the modulator.

In certain embodiments, a high or a low hold voltage and address voltage may be used. Using both positive and negative hold and address voltages allows the polarity of write procedures to be alternated, inhibiting charge accumulation which could occur after write operations of only a single polarity.

FIG. 7A shows an array of pixels (modulators) formed from first through third common lines (rows) and first through third segment lines (columns). In FIG. 7A actuated modulators are non-reflective and illustrated as dark. FIG. 7B is a timing diagram showing a series of common and segment line voltage signals that when applied to a 3×3 array will result in the display arrangement illustrated in FIG. 7A. FIG. 7B is divided by vertical lines into “line times” which assist in describing what is happening to the array at any particular time. For the purposes of this figure, voltages on the common and segments lines during the “first line time” are those displayed in the time period between vertical lines denoted ‘1’ at the bottom of the figure. Likewise, voltages during the “second line time” are those displayed between the vertical lines denoted ‘2’ at the bottom of the figure. These line times are explanatory only and are not intended to be a description of the exact amount or proportion of time necessary for any of the illustrated operations.

Turning to FIG. 7B more specifically now, a first write period 701, spanning line times 2-4, is used to create the array configuration shown in FIG. 7A. During each of the three line times in the first write period 701, one complete row of the array shown in FIG. 7A is written. Further, this first write period 701 in FIG. 7B is illustrated as a “positive” write because the segment voltage used to actuate the pixel is positive.

During line time 2, common line 1 is being addressed. The line is first driven to a release voltage (VC_{REL}) for a release period 770 to release all of the pixels along it—including array locations (1,1), (1,2) and (1,3). Thereafter common line 1 is driven first to a low hold voltage (VC_{HOLD}_{_{—}}_{L}), then to a low address voltage (VC_{ADD}_{_{—}}_{L}), and finally back to the low hold voltage (VC_{HOLD}_{_{—}}_{L}). Because the first two pixels along common line 1 are to be actuated, segment lines 1 and 2 are concurrently driven to a high segment voltage (VS_{H}) during the second line time such that the voltage difference across the pixels located at array locations (1,1) and (1,2) is approximately the absolute difference between VC_{ADD}_{_{—}}_{L} and VS_{H}, which is sufficient to actuate the pixels. The voltage along segment line 3 is left at the low segment voltage (VS_{L}) so that the voltage difference across the pixel at array location (1,3) is lower than the pixel's actuation voltage, leaving the pixel unactuated.

During line time 3, common line 2 is addressed. The line is first driven to a release voltage (VC_{REL}) to release all of the pixels along it—including array locations (2,1), (2,2) and (2,3). Thereafter common line 2 is driven first to a low hold voltage (VC_{HOLD}_{_{—}}_{L}), then to a low address voltage (VC_{ADD}_{_{—}}_{L}), and finally back to the low hold voltage (VC_{HOLD}_{_{—}}_{L}). Because the second pixel along common line 2 is to be actuated, segment line 2 is driven to a high segment voltage (VS_{H}) during the third line time such that the voltage difference across the pixel located at array location (2,2) is approximately the absolute difference between VC_{ADD}_{_{—}}_{L}, and VS_{H}, which is sufficient to actuate the pixel. The voltage along segment line 1 is driven to the low segment voltage (VS_{L}) and the voltage across segment line 3 is left at the low segment voltage (VS_{L}) so that the voltage difference across the pixels at array locations (2,1) and (2,3) is lower than the actuation voltage and the pixels remain unactuated.

During line time 4, common line 3 is addressed so it is first driven to a release voltage (VC_{REL}) to release all of the pixels along it—including array locations (3,1), (3,2) and (3,3). Thereafter common line 3 is driven first to a low hold voltage (VC_{HOLD}_{_{—}}_{L}), then to a low address voltage (VC_{ADD}_{_{—}}_{L}), and finally back to the low hold voltage (VC_{HOLD}_{_{—}}_{L}). Because the last two pixels along common line 3 are to be actuated, segment lines 2 and 3 are concurrently driven to a high segment voltage (VS_{H}) during the fourth line time such that the voltage difference across the pixels located at array locations (3,2) and (3,3) is approximately the absolute difference between VC_{ADD}_{_{—}}_{L} and VS_{H}, which is sufficient to actuate the pixels. The voltage along segment line 1 is left at the low segment voltage (VS_{L}) so that the voltage difference across the pixel at array location (3,1) is lower than the actuation voltage and the pixel remains unactuated.

A first hold 702 period takes place during line times 5 and 6. During this time common lines 1-3 are held at a low hold voltage (VC_{HOLD}_{_{—}}_{L}) and no pixel state in the array is changed.

A second write period 703, spanning line times 7-9, is used to again create the array configuration shown in FIG. 7A. This second write period 703 in FIG. 7B is illustrated to show a “negative” write. Essentially every aspect of this write is the same as the previous description, except the voltages are flipped. As explained above, the voltages are flipped to avoid a build up of capacitance along the lines. Thus, write period 703 is like a screen refresh where the image written during this period is identical to the image written during the previous write period.

During line time 7, common line 1 is addressed. The line is first driven to a release voltage (VC_{REL}) to release all of the pixels along it—including array locations (1,1), (1,2) and (1,3). Thereafter common line 1 is driven first to a high hold voltage (VC_{HOLD}_{_{—}}_{H}), then to a high address voltage (VC_{ADD}_{_{—}}_{L}), and finally back to the high hold voltage (VC_{HOLD}_{_{—}}_{H}). Because the first two pixels along common line 1 are to be actuated, segment lines 1 is left a low segment voltage (VS_{L}) and segment line 2 is driven to a low segment voltage (VS_{L}) during line time 7 such that the voltage difference across the pixels located at array locations (1,1) and (1,2) is approximately the absolute difference between VC_{ADD}_{_{—}}_{H} and VS_{L}, which is sufficient to actuate the pixels. The voltage along segment line 3 is left at the high segment voltage (VS_{H}) so that the voltage difference across the pixel at array location (1,3) is lower than the actuation voltage and the pixel remains unactuated.

During line time 8, common line 2 is addressed. The line is first driven to a release voltage (VC_{REL}) to release all of the pixels along it—including array locations (2,1), (2,2) and (2,3). Thereafter common line 2 is driven first to a high hold voltage (VC_{HOLD}_{_{—}}_{H}), then to a high address voltage (VC_{ADD}_{_{—}}_{H}), and finally back to the high hold voltage (VC_{HOLD}_{_{—}}_{H}). Because the second pixel along common line 2 is to be actuated, segment lines 2 is left at a low segment voltage (VS_{L}) during line time 8 such that the voltage difference across the pixel located at array location (2,2) is approximately the absolute difference between VC_{ADD}_{_{—}}_{H} and VS_{L}, which is sufficient to actuate the pixel. The voltage along segment lines 1 is driven to the high segment voltage (VS_{H}) and the voltage across segment line 3 is left at the high segment voltage (VS_{H}) so that the voltage difference across the pixels at array locations (2,1) and (2,3) is lower than the actuation voltage and the pixels remain unactuated.

During line time 9, common line 3 is addressed. The line is first driven to a release voltage (VC_{REL}) to release all of the pixels along it—including array locations (3,1), (3,2) and (3,3). Thereafter common line 3 is driven first to a high hold voltage (VC_{HOLD}_{_{—}}_{H}), then to a high address voltage (VC_{ADD}_{_{—}}_{H}), and finally back to the high hold voltage (VC_{HOLD}_{_{—}}_{H}). Because the last two pixels along common line 3 are to be actuated, segment line 2 is left at a low segment voltage (VS_{L}) and segment line 3 is driven to a low segment voltage (VS_{L}) during line time 9 such that the voltage difference across the pixels located at array locations (3,2) and (3,3) is approximately the absolute difference between VC_{ADD}_{_{—}}_{H} and VS_{L}, which is sufficient to actuate the pixels. The voltage along segment line 1 is left at the high segment voltage (VS_{H}) so that the voltage difference across the pixel at array location (3,1) is lower than the actuation voltage and the pixel remains unactuated.

FIG. 7B illustrates some undesirable aspects of such a drive scheme. In the first write period 701 and the second write period 703 the second pixel along each common line (row) (i.e. array locations (1,2), (2,2) and (3,2)) is actuated. Because of this, the voltage along segment line 2 should be able to remain constant at either a high address or low address voltage during the addressing of each common line. However, in order to release all pixels along a common line, the voltage across the pixels on that common line needs to be below the relaxation window and preferably as close to the center of the hysteresis curves as possible. Thus, in order to accomplish this, the segment voltage is driven from the high segment voltage VS_{H} to the low segment voltage VS_{L} and back to the high segment voltage VS_{H} two extra times (780 and 781) during the first write period 701. Likewise, during the second write period 703, the voltages along the segment lines are transitioned three extra times, at 790, 791, and 792 to address ensure proper release of the pixels during the release periods on the common lines. These otherwise unnecessary voltage transitions increase overall power consumption of the drive scheme.

Furthermore, as each modulator is released as part of the write procedure prior to addressing the modulator, the sum of actuation time and release time determines the necessary line time. In some embodiments the release time of a modulator is even greater than the actuation time, thus requiring a long line time. This second issue can be addressed by overlapping a release phase for each line with the write phase of the previous line such that they are accomplished concurrently.

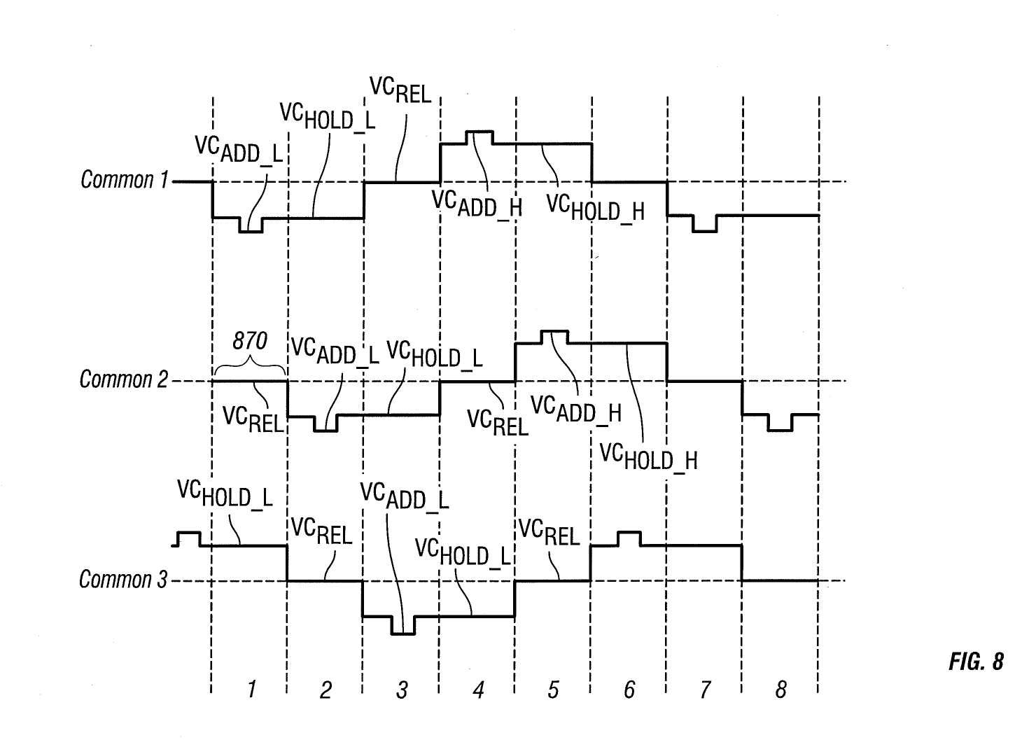

FIG. 8 is a timing diagram which illustrates this concurrent addressing and releasing, a process also known as “pipelining.” As can be seen during line time 1, common line 1 is being addressed with a low address voltage VC_{ADD}_{_{—}}_{L}. Concurrent with this addressing, common line 2 is being released with a release voltage VC_{RL} and common line 3 is being held at a high hold voltage VC_{HOLD}_{_{—}}_{H}. Unlike in FIG. 7B, where addressing and releasing was always done during different line times for different lines, in this embodiment addressing and releasing can be overlapped allowing a longer release period (compare for example release period 870 in FIG. 8 with release period 770 in FIG. 7B) without increasing the line time. The advantage of a longer release period is ensuring that the pixel fully releases; if the release period is too short the pixel may not release fully or at all.

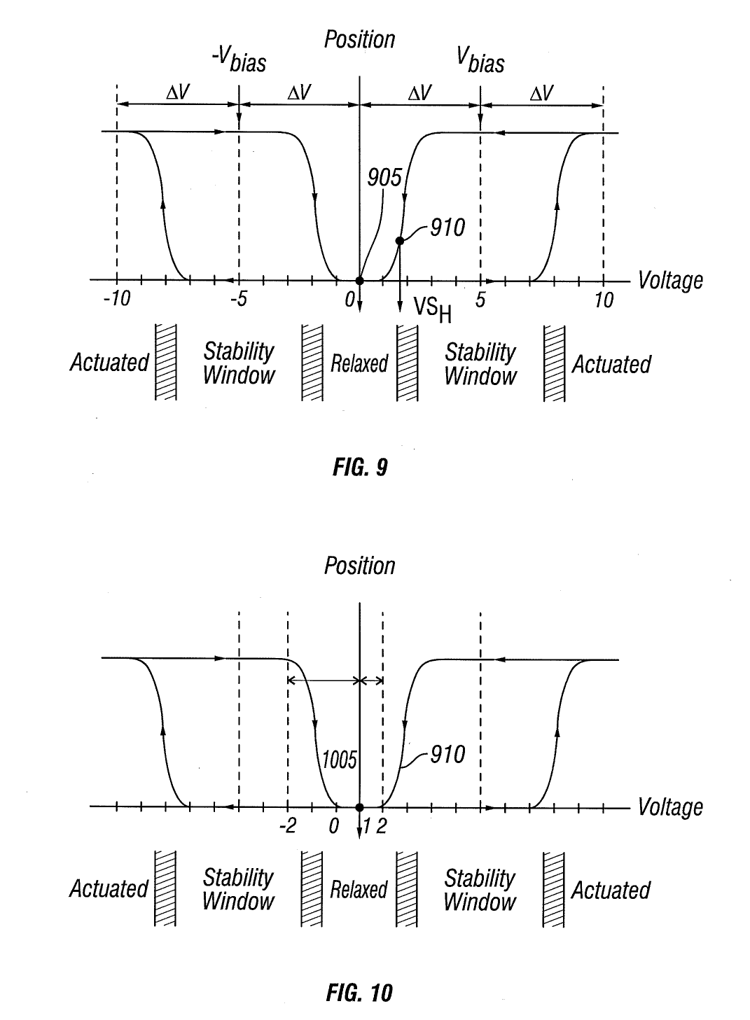

A consequence of overlapping addressing and releasing during a single line time is that during the release of one common line, the segment lines along it are set to voltages suitable for writing the previous line. In this case, as will be discussed further in FIG. 9, the resulting voltage across the pixel may not fully enter the release window of the hysteresis curve associated with the pixel and the pixel may release very slowly or not at all. Either of these situations is undesirable.

FIG. 9 shows an exemplary hysteresis curve for an exemplary electromechanical device such as an IMOD pixel. As was described above, with reference to FIG. 3, the movable layer of the electromechanical device in this example does not relax completely until the voltage drops below 2 volts. At zero volts (as shown in FIG. 9 at 905) across the electromechanical device, the device is at its target release voltage centered between the hysteresis windows. However, as discussed in FIG. 8, in some drive schemes, during the release phase, the electromechanical device has a resulting voltage that is not comfortably within the release window (here, 0 volts is the target release voltage). In these schemes the pixel may see voltages up to the segment line voltage (either VS_{H} or VS_{L}) during the release phase. Though the segment line voltage is typically a relatively low absolute voltage, it may approach the release voltage threshold for the electromechanical device (as shown in FIG. 9 at 910). In such cases, the electromechanical device may release very slowly or not at all, which results in a lower frame rate and a lower yield for a display. While setting the segment line voltage lower may militate against this specific problem, for other aspects of the drive scheme, maximizing segment drive voltage is desirable. In particular, the electromechanical device's actuation time is shorter with a larger segment drive voltage.

FIG. 10 shows a right-shifted hysteresis curve for an exemplary electromechanical device such as an IMOD pixel. As described above with reference to FIG. 3, the hysteresis curve for a different IMOD pixel may be centered on a different voltage, offset from 0 volts, such as, for example, a +1 offset voltage, and may take on different shapes such that the stability and actuation windows are defined by different voltage ranges. In FIG. 10, the center of the hysteresis windows 1005 is at +1 volt and represents a target release voltage. In FIG. 10, for example, the target release voltage 1005 corresponds with the middle of the relaxation window, or +1 volt. In this example, the low segment voltage (VS_{L}) is −2 volts and the high segment voltage (VS_{H}) is +2 volts. In this example, the segment voltages are not equally spaced on either side of the target release voltage.

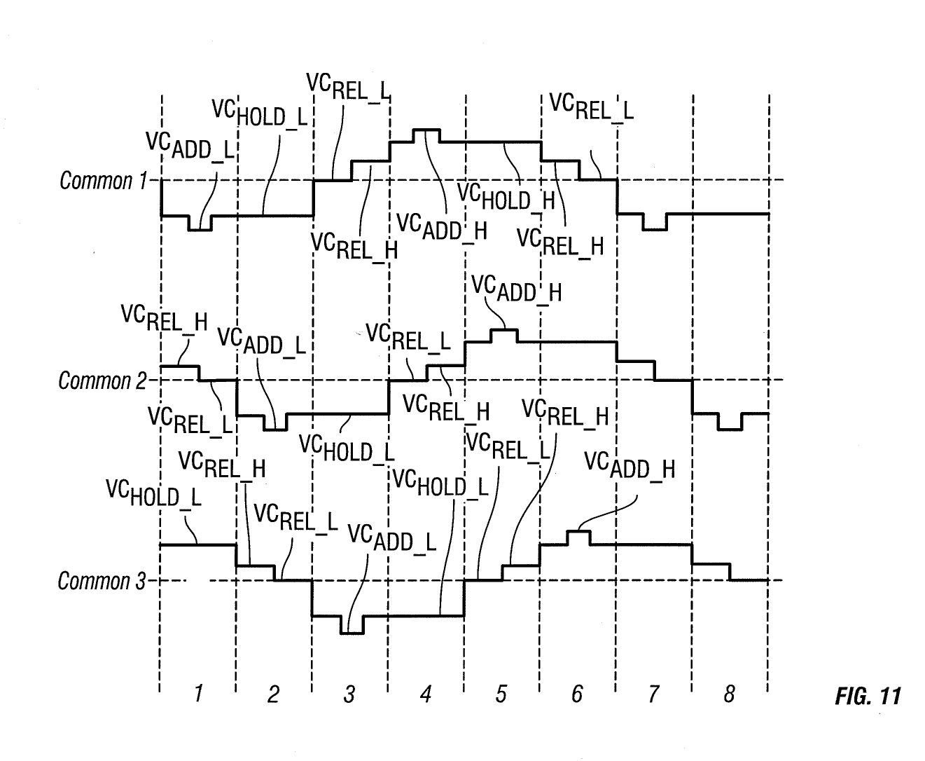

FIG. 11 shows an improved drive scheme and an embodiment of the present invention. The drive scheme for the common line now has six voltage levels including: a high address voltage (VC_{ADD}_{_{—}}_{H}), a high hold voltage (VC_{HOLD}_{_{—}}_{H}), a high release voltage (VC_{REL}_{_{—}}_{H}), a low release voltage (VC_{REL}_{_{—}}_{L}), a low hold voltage (VC_{HOLD}_{_{—}}_{L}) and a low address voltage (VC_{ADD}_{_{—}}_{L}). The segment lines (not shown in FIG. 11) are transitioned between two voltage levels: high segment voltage (VS_{H}) and low segment voltage (VS_{L}).

FIG. 11 is similar to FIG. 8 with the exception of a new release scheme which illustrates one embodiment of the invention. During each release phase, the common line voltage is transitioned through two voltages: the high and low release voltages (VC_{REL}_{_{—}}_{H} & VC_{REL}_{_{—}}_{L}), though not necessarily in that order. As is shown, for example, during line time 1 on common line 2, during the release phase, the release voltage is first set to the high release voltage (VC_{REL}_{_{—}}_{H}) and then the low release voltage (VC_{REL}_{_{—}}_{L}) before beginning a positive write at line time 2. Similarly, but in reverse order, during line time 3 on common line 1, the release voltage is set to the low release voltage (VC_{REL}_{_{—}}_{L}) and then to the high release voltage (VC_{REL}_{_{—}}_{H}) before beginning a negative write at line time 4. For a hysteresis curve symmetric about zero volts, the high release voltage (VC_{REL}_{_{—}}_{H}) may be substantially equal to the high segment voltage (VS_{H}) and the low release voltage (VC_{REL}_{_{—}}_{L}) may be substantially equal to the low segment voltage (VS_{L}). Thus, during some period of the release phase, the common line voltage and the segment voltage will be equal, regardless of the state of the segment line. Accordingly, during each release phase, the resulting voltage across any pixel, which is the difference between the common line voltage and the segment line voltage at that pixel, will be substantially zero, the target release voltage for this embodiment, during either the high release voltage period of the release phase or the low release voltage period of the release phase. In other embodiments, the high release voltage (VC_{REL}_{_{—}}_{H}) and the low release voltage (VC_{REL}_{_{—}}_{L}) may be set to different voltages to achieve a non-zero target release voltage (such as that shown in FIG. 10, above). Generally, in these embodiments, the high and low release voltages (VC_{REL}_{_{—}}_{H} & VC_{REL}_{_{—}}_{L}) would be the high and low segment voltages (VS_{H} & VS_{L}) plus the offset voltage. In both cases, the split release phase results in a voltage difference across the device during one phase that is closer to the target release voltage than either of the segment voltages (VS_{H} & VS_{L}). Notably, because small differences or fluctuations in the common and segment line voltages are possible, those skilled in the art will appreciate that this release scheme will work effectively where the voltage across the device is substantially equal to the target release voltage i.e. within approximately 0.5 volts of the target release voltage.

This embodiment of the drive scheme has additional benefits beyond guaranteeing substantially the target release voltage across a pixel during the release phase. For example, because the high and low release phase voltages are voltages that are transitioned through automatically—through very briefly—between successive negative and positive address phases, there is no additional power consumption by selecting each voltage for a period of time during the release phase. Further, in embodiments where the high and low release voltages are substantially equal to the high and low segment voltages, which are in general much lower than the common line address voltages, a lower voltage power source can be used to drive the voltage on the common line from the low release voltage (VC_{REL}_{_{—}}_{L}) to the high release voltage (VC_{REL}_{_{—}}_{H}) or vice versa. Since lower voltage power sources are typically more efficient than higher voltage power sources in terms of total power consumption, and because the higher voltage source need only be used to raise the common line voltage from the low release voltage (VC_{REL}_{_{—}}_{L}) to the low address voltage (VC_{ADD}_{_{—}}_{L}) or the high release voltage (VC_{REL}_{_{—}}_{H}) to the high address voltage (VC_{ADD}_{_{—}}_{H}), the overall power consumption is beneficially reduced. Finally, this scheme still provides longer release periods because of pipelining, as compared to those in FIG. 7B, which ensures proper release of all pixels.

Although the present invention has been described in detail, it should be understood that various changes, substitutions, and alterations can be made hereto without departing from the spirit and scope of the invention as defined by the following claims.

What is claimed is:

1. A method of releasing an electromechanical device, comprising:
applying a first release voltage on a common line for a first release time period;
applying a second release voltage on a common line for a second release time period, wherein the second release voltage is different than the first release voltage; and
wherein a resulting voltage across the electromechanical device is closer to a target release voltage during one of the first or second release time periods than the other.

2. The method of claim 1 wherein the first release voltage is substantially equal to a maximum segment voltage.

3. The method of claim 1 wherein the second release voltage is substantially equal to a minimum segment voltage

4. The method of claim 1 wherein the first release time period and the second release time period are substantially equal.

5. The method of claim 1 where the target release voltage is zero.

6. A method of driving an electromechanical device, the electromechanical device comprising a first electrode in electrical communication with a segment line spaced apart from a second electrode in electrical communication with a common line, the method comprising:
applying a segment voltage on the segment line, wherein the segment voltage varies between a maximum segment voltage and a minimum segment voltage, and wherein a difference between the maximum segment voltage and the minimum segment voltage is less than a width of a hysteresis window of the electromechanical device;
applying a release waveform on the common line, wherein the release waveform is maintained at a first release voltage substantially equal to the maximum segment voltage for a first release time period and then maintained at a second release voltage substantially equal to the minimum segment voltage for a second release time period;
applying an addressing voltage on the common line, wherein the addressing voltage is configured to cause the electromechanical device to actuate based upon the state of the segment voltage; and
applying a hold voltage on the common line, wherein the hold voltage is configured to maintain the electromechanical device in its current state, regardless of the state of the segment voltage.

7. The method of claim 6, wherein the electromechanical device is an interferometric modulator.

8. The method of claim 6, wherein the electromechanical device is in an array comprising a plurality of electromechanical devices, and wherein each electromechanical device is in electrical communication with a segment line spaced apart from a second electrode in electrical communication with a common line.

9. A display device comprising:
an array of electromechanical display elements, wherein each display element is in electrical communication with a common line and a segment line; and
driver circuitry configured to perform a method of driving the electromechanical display elements, wherein the method comprises:
applying a segment voltage on the segment line, wherein the segment voltage varies between a maximum segment voltage and a minimum segment voltage, and wherein a difference between the maximum segment voltage and the minimum segment voltage is less than a width of a hysteresis window of the electromechanical device;
applying a release waveform on the common line, wherein the release waveform is maintained at a first release voltage substantially equal to the maximum segment voltage for a first release time period and then maintained at a second release voltage substantially equal to the minimum segment voltage for a second release time period;
applying an addressing voltage on the common line, wherein the addressing voltage is configured to cause the electromechanical device to actuate based upon the state of the segment voltage; and
applying a hold voltage on the common line, wherein the hold voltage is configured to maintain the electromechanical device in its current state, regardless of the state of the segment voltage.

10. The display of claim 9, wherein the electromechanical device is an interferometric modulator.

11. A display system comprising:
one or more electromechanical devices, wherein each electromechanical device is in electrical communication with a segment line spaced apart from a second electrode in electrical communication with a common line;
a driver circuit configured to apply a first release voltage on a common line for a first release time period;
a driver circuit configured to apply a second release voltage on a common line for a second release time period, wherein the second release voltage is different than the first release voltage; and
wherein a resulting voltage across the electromechanical device is closer to a target release voltage during one of the first or second release time periods than the other.

12. The display systems of claim 11 further comprising a driver circuit configured to apply a hold voltage on a common line, wherein the hold voltage is configured to keep an electromechanical device in communication with said common line in its present state.

13. The display system of claim 11 further comprising a driver circuit configured to apply an address voltage on a common line, wherein the address voltage is configured to change the state of an electromechanical device in communication with said common line.

14. The display system of claim 11 further comprising a driver circuit configured to apply a segment voltage to a segment line.

15. This display system of claim 14 wherein the driver circuit configured to apply a segment voltage is configured to apply at least a high segment voltage and a low segment voltage to a segment line.

16. The display system of claim 12 wherein the driver circuit configured to apply a hold voltage is configured to apply at least a high hold voltage and a low hold voltage to a common line.

17. The display system of claim 13 wherein the driver circuit configured to apply an address voltage is configured to apply at least a high address voltage and a low address voltage to a common line.

18. The display system of claim 13 wherein the state of the electromechanical device is one of actuated or released.

19. A display system comprising:
one or more electromechanical devices, wherein each electromechanical device is in electrical communication with a segment line spaced apart from a second electrode in electrical communication with a common line;
means for applying a first release voltage on a common line for a first release time period;
means for applying a second release voltage on a common line for a second release time period, wherein the second release voltage is different than the first release voltage; and
wherein a resulting voltage across the electromechanical device is closer to a target release voltage during one of the first or second release time periods than the other.

20. The display systems of claim 19 further comprising means for applying a hold voltage on a common line, wherein the hold voltage is configured to keep an electromechanical device in communication with said common line in its present state.

21. The display system of claim 19 further comprising means for applying an address voltage on a common line, wherein the address voltage is configured to change the state of an electromechanical device in communication with said common line.

22. The display system of claim 19 further comprising means for applying a segment voltage to a segment line.

23. This display system of claim 22 wherein the means for applying a segment voltage is configured to apply at least a high segment voltage and a low segment voltage to a segment line.

24. The display system of claim 20 wherein the means for applying a hold voltage is configured to apply at least a high hold voltage and a low hold voltage to a common line.

25. The display system of claim 21 wherein the means for applying an address voltage is configured to apply at least a high address voltage and a low address voltage to a common line.

26. The display system of claim 21 wherein the state of the electromechanical device is one of actuated or released.

27. A display device comprising:
an array of electromechanical display elements, wherein each display element is in electrical communication with a common line and a segment line;
means for applying a segment voltage on the segment line, wherein the segment voltage varies between a maximum segment voltage and a minimum segment voltage, and wherein a difference between the maximum segment voltage and the minimum segment voltage is less than a width of a hysteresis window of the electromechanical device;
means for applying a release waveform on the common line, wherein the release waveform is maintained at a first release voltage substantially equal to the maximum segment voltage for a first release time period and then maintained at a second release voltage substantially equal to the minimum segment voltage for a second release time period;
means for applying an addressing voltage on the common line, wherein the addressing voltage is configured to cause the electromechanical device to actuate based upon the state of the segment voltage; and
means for applying a hold voltage on the common line, wherein the hold voltage is configured to maintain the electromechanical device in its current state, regardless of the state of the segment voltage.
